(19) United States
(12) Patent Application Publication
(10) Pub. No.: US 2024/0025157 A1
(43) Pub. Date: Jan. 25, 2024

(54) AN IMPROVED CONSTRAINED LAYER DAMPENING MATERIALS AND SYSTEM FOR USE WITH OILY SUBSTRATES

(71) Applicant: Nitto, Inc., Teaneck, NJ (US)

(72) Inventors: Lin SONG, Kansas City, MO (US); James FREITAG, Kansas City, MO (US); Elvis ENEH, Kansas City, MO (US); Craig SCHUTZLER, Kansas City, MO (US); David LEIP, Kansas City, MO (US)

(73) Assignee: Nitto, Inc., Teaneck, NJ (US)

(21) Appl. No.: 18/038,924

(22) PCT Filed: Nov. 25, 2021
(86) PCT No.: PCT/US21/60882

§ 371 Date: May 25, 2023

Related U.S. Application Data
(60) Provisional application No. 63/118,546, filed on Nov. 25, 2020.

(51) Int. Cl. B32B 25/18; B32B 37/26

(52) U.S. Cl. CPC B32B 25/18; B32B 37/26; B32B 2307/102; B32B 2037/268; B32B 2307/4026; B32B 2305/30; B32B 2556/00

(57) ABSTRACT

An improved constrained layer vibration dampening patch for use directly on substrates with rust protective coatings. The improved constrained layer vibration dampening patch includes a constraining layer, a dampening layer and a release liner. The improved constrained layer vibration dampening patch includes a dampening layer with about 10 to about 15 weight percent of a butyl rubber composition; about 1 to about 5 weight percent of a tackifier; about 20 to about 25 weight percent of a plasticizer; about 60 to about 65 weight percent of filler; and about 0.01 to 1 weight percent of colorant, wherein the composition is substantially free of a curing agent, and wherein the composition is free of any ethylene copolymers.

### CROSS-REFERENCE TO RELATED APPLICATIONS SECTION

This application is PCT Application that claims priority to U.S. Provisional Patent Application Ser. 63/118,546 filed on Nov. 25, 2020, the entire contents of which are hereby incorporated by reference in their entirety.

### FIELD OF THE INVENTION

This invention relates to constrained layer dampening systems and dampening layer compositions and more particularly, to constrained layer vibration damping systems and damping layer compositions for use with oil coated substrates.

### BACKGROUND OF THE INVENTION

Vibration dampening systems are widely used with in the automobile industry for reducing vibrations and sounds generated by rotating transmissions, axle linkages, rotating bearings and rotating tires. The vibration dampening systems are typically applied to selected parts or areas of the automobile such as the inner quarter panels, floors, roofs, etc. to prevent the vibrations from being transmitted inside the automobile passenger compartments.

Typical dampening systems include a thermoplastic or rubber layer and a constraining layer that together suppress the vibrations. There are several different dampening systems used, including peel and stick, spray-on full panel damping, and constrained layer dampening. However, there are several problems with the current systems, such as proper location of the systems, high cost of installation, unwanted gaps between layers and delamination of the system during assembly of the automobile. The problem of delamination is due in part to the protective coatings that are applied to the metal body parts. Currently, they overcome the delamination problem by timely and expensive cleaning of the metal surfaces. Hence, there is need in the art for a vibration dampening system and dampening materials which can be applied directly to the protective coated metal without loss of adhesion or vibration dampening.

### SUMMARY OF THE INVENTION

An improved constrained layer vibration dampening patch is provided, which includes a constraining layer, a dampening layer, and a release liner. In some embodiments, the improved constrained layer vibration dampening patch can further comprise a colorant.

The improved constrained layer vibration dampening patch can include a dampening layer comprising about 10 to about 15 weight percent of a butyl rubber composition, about 1 to 5 weight percent of a tackifier, 20 to 25 weight percent of a plasticizer, and 60 to 65 weight percent of filler.

In some embodiments, the release liner may be removed, and the remaining patch can be placed over the substrate such as the interior surface of a vehicle door or body panel, thus forming a sandwich construction comprising the dampening layer intermediate the constraining layer and the substrate. The substrate can contain a protective coating, such as mineral oil, for prevention of rust. The improved constrained layer vibration dampening patch may be used directly on the oily surface of the substrate.

### BRIEF DESCRIPTION OF THE DRAWINGS

FIG. 1 shows a schematic, cross-sectional view of an improved constrained layer vibration dampening patch embodiment of the present invention.

FIG. 2 shows a schematic, cross-sectional view of an improved constrained layer vibration dampening patch adhered to a substrate.

### DETAILED DESCRIPTION

The improved constraining layer vibration dampening patch of the present invention provides advantages over the prior vibration dampening materials used in the automotive industry. The present improved vibration dampening patch eliminated the need to remove the oily protective layer coating the automotive surfaces which the improved vibration dampening patch is adhered, thus reducing production time and costs. The patch may be applied to surfaces of substrates in fields other than automotive and is not restricted in its use.

Hereinafter the invention will be described more particularly by way of preferred embodiments with references to the accompanying drawings.

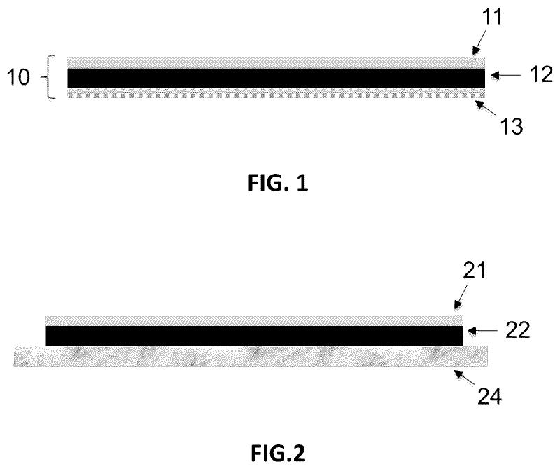

Referring to FIG. 1, shown in cross section, is the improved vibration dampening patch of the present invention. As seen in FIG. 1, the improved constrained layer vibration dampening patch can comprise a laminated sheet 10, comprising a constraining layer 11, a dampening layer 12, and a release liner 13.

The constraining layer may be formed from metallic non-ferrous materials such as aluminum foil, copper foil, stainless steel foil, cold rolled steel, etc. When a copper foil or cold rolled steel foil is utilized, the material may be protected with a coating effective at preventing oxidation of the material. In other embodiments, the constraining layer may be comprised of rigid non-metallic materials such polypropylene, glass cloth (woven cloth made from glass fibers), light weight foam, cardboard, wood or any other rigid material.

The form of the constraining layer can affect the properties of the dampening layer 12 or assist in the dampening of various resonance frequencies such as acoustic or vibration dissipation. The constraining layer may comprise a smooth, dimpled, ridged or wave/corrugated surface.

The dampening layer 12 can comprise a butyl rubber composite, a tackifier, a plasticizer, and a filler composite. The butyl rubber composite allows flexibility and wetting of the dampening layer during production of the improved constrained layer vibration dampening patch. The flexibility and wetting properties of the butyl rubber prevents the layer from breaking down over its life, for example, by preventing delamination from the adherent, shrinkage over time due to formation stresses during the production process, and adhering to non-planar substrates. When the dampening layer breaks down, it cannot effectively dampen the vibration and acoustic resonances that are generated by the automobile. In some embodiments, the butyl rubber composite can be comprised of a partially crosslinked butyl rubber and an isobutylene-isoprene butyl rubber (IIR) composite.

The partially crosslinked butyl rubber component of the dampening layer is commercially available as Polysar Butyls XL 10000, XL 68102, XL 30102, and XL 40302 (Polysar International Co.), Butyx 55, Butyx 63, Butyx 75 and Butyx 80 (Harmony Elastomers, LLC., Clifton, New Jersey, USA) and NexGen® XL-15, NexGen® XL46, NexGen® XL-63 (Alterra Holdings Co. Seymour, Indiana, USA). In some embodiments, the partially crosslinked butyl rubber may be comprised of NexGen® XL-15.

In some embodiments the amount of partially crosslinked butyl rubber in the dampening layer may comprise about 0.1 to about 5 weight percent (wt %), of the total weight of the dampening layer composition. In some embodiments, the amount of partially crosslinked butyl rubber may comprise about 0.1 to about 0.5 wt %, about 0.5 to about 1 wt %, about 1 to about 1.5 wt %, about 1.5 to about 2 wt %, about 2 to about 2.5 wt %, about 2.5 to about 3 wt %, about 3 to about 3.5 wt %, about 3.5 to about 4 wt %, about 4 to about 4.5 wt %, and about 4.5 to about 5 wt % of the total weight of the dampening layer composition. More particularly, the amount of the partially crosslinked butyl rubber is 1 wt %, 1.1 wt %, 1.2 wt %, 1.3 wt %, 1.4 wt %, 1.5 wt %, 1.6 wt %, 1.7 wt %, 1.8 wt %, 1.9 wt % or 2 wt % of the total weight of the dampening layer composition. As used herein the term “about” when describing a value or parameter includes the indicated amount ±10%. In some embodiments, the term “about” includes the indicated amount ±5%. In still other embodiments, the term “about” includes the indicated amount ±1%.

The IIR butyl rubber composite of the dampening layer is comprised of a commercially available non-halogenated IIR butyl rubber and recycled IIR butyl rubber. Suitable commercially available non-halogenated IIR butyl rubbers include X-Butyl® RB100, X-Butyl® RB301, and X-Butyl® RB402 (Arlanxeo Co., Maastricht, Netherlands), Butyl 065, Butyl 077, Butyl 165, Butyl 268, Butyl 365 and Exxpro 96-1 (ExxonMobil Chemical). In some embodiment the IIR butyl rubber can be X-Butyl® RB301. The recycled butyl rubber is synthetic butyl rubber and is commercially available from Milin Environmental, Inc. (Simcoe, ON, Canada). In some embodiments, the recycled IIR butyl rubber can be about 1 to about 5 wt % of the total weight of the dampening layer composition. In some embodiments, the recycled IIR butyl rubber can be a synthetic butyl rubber. In some embodiments, the ratio of recycled IIR butyl rubber to IIR butyl rubber can be from about 1:4 to about 1:6.

In some embodiments, the IIR butyl rubber component of the butyl rubber composite can be in the amount of about 5 to about 10 wt % of the total weight of the dampening layer composition. In some embodiments, the amount of the IIR butyl rubber component of the butyl rubber composite may be about 5 to about 5.5 wt %, about 5.5. to about 6 wt %, about 6 to about 6.5 wt %, about 6.5 to about 7 wt %, about 7 to about 7.5 wt %, about 7.5 to about 8 wt %, about 8 to about 8.5 wt %, about 8.5 to about 9 wt % about 9 to about 9.5 wt %, about 9.5 to about 10 wt %, or any amount covered by the ranges above. Of particular interest are the amounts of 7.5 wt %, about 7.6 wt %, about 7.7 wt %, about 7.8 wt %, about 7.9 wt %, and about 8 wt %.

In some embodiments, the recycled IIR butyl rubber component of the butyl rubber composite can be in the amount of about 1 to about 5 wt % of the total weight of the dampening layer composition. In some embodiments, the amount of the recycled IIR butyl rubber component of the butyl rubber composite can be about 1 to about 1.5 wt %, about 1.5 to about 2 wt/o about 2 to about 2.5 wt % about 2.5 to about 3 wt % about 3 to about 3.5 wt %, about 3.5 to about 4 wt %, about 4 to about 4.5 wt %, about 4.5 to about 5 wt %, or any amount bound by the above ranges. Of particular interest are the amounts of 1.3 wt %, 1.5 wt %, 1.7 wt %, 1.9 wt %, and 2 wt % of the total weight of the dampening layer composition.

The tackifier of the dampening layer is comprised of a commercially available rosin ester, an aliphatic hydrocarbon resin, or mixtures thereof. The tackifier is used to provide softness and high initial adhesivity to the dampening layer composition. The tackifier is preferably present in the amount of about 2 to about 6 wt % of the total weight of the dampening layer composition. In some embodiments, the preferred amount of tackifier may be about 2 to about 2.5 wt %, about 2.5 to about 3 wt %, about 3 to about 3.5 wt %, about 3.5 to about 4 wt %, about 4 to about 4.5 wt %, about 4.5 to about 5 wt %, about 5 to about 5.5 wt %, about 5.5 to about 6 wt %, or any amount bound by the ranges above. In some embodiments, the amount of tackifier is preferably about 2.9 wt %, about 4 wt %, about 4.3 wt %, or about 6 wt %.

Suitable commercially available rosin ester resins include, but are not limited to, Treckos R86, Treckos R98, Treckos R100 (Teckrez, Inc., Jacksonville FL, USA), Foral 85, Foral 105, Hercolyn (Hercules Powder Co., Wilmington, DE, USA), or mixtures thereof. In some embodiments, the tackifier may be Treckos R98 rosin ester.

Suitable commercially available aliphatic hydrocarbon resins include, but are not limited to, Escorez 1102, Escorez 1304, Escorez 1315 (ExxonMobil Chemical), Nevtec 10, Nevtec 80, Nevtec 100 (Neville Chemical Co., Pittsburgh, PA, USA), Wingtack 10, Wingtack 95, Wingtack Plus (Goodyear Tire & Rubber co., Akron, OH, USA), Piccotac 100, Piccotac B, Piccotac 95, Piccotac 115 (Hercules Powder Co.) or mixtures thereof. In some embodiments, the tackifier can be Wingtack 95 aliphatic hydrocarbon resin.

The plasticizer of the dampening layer is used to impart softness, increase the initial adhesiveness, and modify the viscosity of the dampening layer. Plasticizers suitable for use with the butyl rubber composite may include, but are not limited to, polybutene plasticizers, such as Indopol® H100, Indopol® H300, Indopol® H1200, Indopol® H1500, Indopol® H1900, Indopol® H2100 (INEOS Oligomers, Alvin, TX, USA), Parapol 700, Parapol 950, Parapol 1300, Parapol 2100 (ExxonMobil Chemicals), Opanol B10, Opanol B12, Opanol B15 (BASF Chemical Co., Ludwigshafen, Germany), or mixtures thereof. Any other plasticizers or combinations of plasticizers can be used.

One or more plasticizers can be used in the dampening layer in the amount of about 20 to about 25 wt % of the total weight of the dampening layer composition. In some embodiments, the preferred amount of plasticizer may be about 20 to about 21 wt %, about 21 to about 22 wt %, about 22 to about 23 wt %, about 23 to about 24 wt %, about 24 to about 25 wt %, or any amount bound by the ranges above. Some preferable amounts of plasticizer are 21.3 wt %, 21.7 wt %, 22.1 wt %, 22.2 wt % and 22.4 wt %.

The filler composite of the dampening layer can be comprised of a general filler, a functional filler or mixtures thereof. The fillers can comprise organic or inorganic material, such as but not limited to, calcium carbonate, talc, quick lime, kaolin clay, silica, mica or other mineral fillers known in the art. In some embodiments, the general filler can comprise calcium carbonate. A commercially available calcium carbonate can be, by way of example, Hubercarb Q325 (Huber Engineered Materials, Atlanta, GA, USA). Examples of commercially available functional fillers include, but are not limited to, HC-75 Clay (Akrochem Co., Akron OH, USA), Silverline 303 Talc (IMCD, Westlake OH, USA), Microcal OF200 Quick Lime (Mississippi Lime Co., St. Louis, MO, USA), or mixtures thereof. The filler composite can comprise mixtures of general and functional fillers in the amounts of about 60 to about 65 wt % of the total weight of the dampening layer composition, preferably between about 62 to about 62.5 wt %, about 62.5 to about 63 wt %, about 63 to about 63.5 wt %, about 63.5 to about 64 wt %, about 64 to about 64.5 wt %, about 64.5 to about 65 wt %, or any amount bound by these ranges.

In some embodiments, the improved constrained layer vibration dampening patch can further comprise a colorant. The colorant is not limiting; examples of colorants may include N650 Carbon Black (The Cary Co., Addison, IL, USA), B22237 (Spartech LLC, Clayton MO, USA), or other colorants not mentioned. The colorant or mixtures of colorant may be used in the amounts of 0.1 to 1 wt % of the total weight of the dampening layer composition.

In some embodiments, the improved constrained layer vibration dampening patch can further comprise a release liner. The release liner is not particularly limited and one skilled in the art could select a release liner from those known in the art for the purpose of structural support. In some embodiments, the release liner can be comprised of non-woven material, woven material, or a woven substrate. Examples of woven substrates include but are not limited to silica (glass) aramid, carbon fiber, metal oxide, minerals, ceramic, or other synthetic man-made fibers. Some non-limited examples of non-woven materials include cellulose, rayon, cloth polyamide fluoride (PVDF), polyethylene (PE), polyethylene terephthalate (PET), polyether ketone (PEEK), and/or mixtures thereof. In some embodiments, the backing layer can be comprised of polyethylene terephthalate.

Some embodiments include a vibration dampening patch composition comprising about to 15 wt % of a butyl rubber composition; about 1 to 5 wt % of a tackifier; about 20 to 25 wt % of a plasticizer; about 60 to 65 wt % of filler; and about 0.1 to 1 wt % of a colorant.

In some embodiments, the improved constrained layer vibration dampening patch can include a release liner, a constraining layer and a dampening layer. In some embodiments, the improved vibration dampening patch may include a metal substrate to which the patch is adhered. In some embodiments, the dampening layer comprises a first surface and a second surface, wherein the constraining layer is in physical communication with the first surface of the dampening layer and the release liner is in physical communication with the second surface of the dampening layer. The dampening layer of the improved constrained layer vibration dampening patch may comprise a butyl rubber composite comprising a poly-isobutylene butyl rubber and an isobutylene-isoprene butyl rubber. In some embodiments, the release liner is removed from the second surface of the dampening layer, exposing said second surface of the dampening layer; the dampening layer is then adhered to the metal substrate such that the second surface of the dampening layer is in physical communication with the metal substrate, resulting in the dampening layer being intermediate the constraining layer and the metal substrate. In some embodiments, the dampening layer may be comprised of about 10 to 15 wt % of butyl rubber composite. The metal substrate may be coated with a protective coating for the inhibition of rust.

The protective coating can be comprised of about 60 to 70 percent of mineral oil. The protective coating can be for example Ferrocote® 61 MAL HCL1 (Quaker Chemical Co., Conshohochken, PA, USA). In some embodiments, the improved constrained layer vibration dampening patch can exhibit a peel adhesion strength of between 9 to about 13 N/cm as measured according to the ISO 8510 protocol.

In general, the dampening layer of the present disclosure may be prepared by a blending the partially crosslinked butyl rubber and an isobutylene-isoprene butyl rubber composite together with the tackifier, the plasticizer and filler, mixing the blend at 90° C. to 140° C. for about 45 min. to 120 min, until the mix reaches the maximum amps for batch pulling (the maximum amps are the peak value for the mixer during mixing which is 150 amps).

The result dampening layer 12 may be extruded between a constraining layer 11 and a release liner 13 as shown in FIG. 1, resulting in the improved constrained layer vibration dampening patch of the present invention. In some embodiments, the release liner may be removed, and the remaining patch can be placed over the substrate 24 such as the interior surface of a vehicle door or body panel, thus forming a sandwich construction comprising the dampening layer 22 intermediate the constraining layer 21 and the substrate 24 as shown in FIG. 2.

Unless otherwise indicated, all numbers expressing quantities of ingredients, properties such as molecular weight, reaction conditions, and so forth used in the specification and embodiments are to be understood as being modified in all instances by the term “about.” Accordingly, unless indicated to the contrary, the numerical parameters set forth in the specification and attached embodiments are approximations that may vary depending upon the desired properties sought to be obtained at the very least, and not as an attempt to limit the application of the doctrine of equivalents. To the scope of the embodiments, each numerical parameter should at least be construed in light of the number of reported significant digits and by applying ordinary rounding techniques.

For the processes and/or methods disclosed, the functions performed in the processes and methods may be implemented in differing order, as may be indicated by context. Furthermore, the outlined steps and operations are only provided as examples and some of the steps and operations may be optional, combined into fewer steps and operations, or expanded into additional steps and operations.

This disclosure may sometimes illustrate different components contained within, or connected with, different other components. Such depicted architectures are merely examples, and many other architectures can be implemented which achieve the same or similar functionality.

The terms used in this disclosure and in the appended embodiments, (e.g., bodies of the appended embodiments) are generally intended as “open” terms (e.g., the term “including” should be interpreted as “including, but not limited to,” the term “having” should be interpreted as “having at least,” the term “includes” should be interpreted as “includes, but not limited to,” etc.). In addition, if a specific number of elements is introduced, this may be interpreted to mean at least the recited number, as may be indicated by context (e.g., the bare recitation of “two recitations,” without other modifiers, means at least two recitations of two or more recitations). As used in this disclosure, any disjunctive word and/or phrase presenting two or more alternative terms should be understood to contemplate the possibilities of including one of the terms, either of the terms, or both terms. For example, the phase “A or B”: will be understood to include the possibilities of “A or B” or “A and B.”

The terms “a,” “an,” “the” and similar referents used in the context of describing the present disclosure (especially in the context of the following embodiments) are to be construed to cover both the singular and the plural, unless otherwise indicated herein or clearly contradicted by context. The use of any and all examples, or related language (e.g., “such as”) provided herein is intended merely to better illuminate the present disclosure and does not pose a limitation on the scope of any embodiments. No language in the specification should be construed as indicating any non-embodied element essential to the practice of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended embodiments.

Certain embodiments are described herein, including the best mode known to the inventors for carrying out the present disclosure. Of course, variations on these described embodiments, will become apparent to those of ordinary skill in the art upon reading the foregoing description. The inventor expects skilled artisans to employ such variations as appropriate, and the inventors intend for the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context. In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments are not limited to the embodiments precisely as shown and described.

### EXAMPLES

The examples in the following tables further illustrate various aspects of the invention. In the following examples, all composition data are given as weight percent for the specified component based on the total weight of the dampening layer composition. Compositions according to the following examples have been prepared, and their physical characteristics have been measured, as indicated in the data below.

### Example 1: Comparative Example (CE)

The dampening layer formula for the comparative example and its ingredients can be found in Table 1 below:

TABLE 1

| Ingredient | Formula (wt. lbs) |
|---|---|
| Partially Crosslinked Butyl Rubber | 100 |
| IIR Butyl Rubber | 35 |
| Tackifier | 110 |
| Plasticizer | 118 |
| Calcium Carbonate Filler | 800 |
| Talc Filler | 300 |
| Clay Filler | 150 |
| Functional Filler | 25 |
| Colorant | 3 |

### Example 2: CLDP-1

The dampening layer formula for the example CLDP-1 and its ingredients can be found in Table 2 below:

TABLE 2

| Ingredient | Formula (wt. lbs) |
|---|---|
| Partially Crosslinked Butyl Rubber | 25 |
| IIR Butyl Rubber | 150 |
| Recycled Butyl Rubber | 38 |
| Plasticizer | 382 |
| Tackifier | 82.5 |
| Synthetic Rubber Plasticizer | 44 |
| Calcium Carbonate Filler | 900 |
| Talc Filler | 250 |
| Functional Filler | 50 |
| Colorant | 3 |

### Example 3: CLDP-2

The dampening layer formula for the example CLDP-2 and its ingredients can be found in Table 3 below:

TABLE 3

| Ingredient | Formula (wt. lbs) |
|---|---|
| Partially Crosslinked Butyl Rubber | 25 |
| IIR Butyl Rubber | 150 |
| Recycled Butyl Rubber | 25 |
| Plasticizer | 409.5 |
| Tackifier | 82.5 |
| Calcium Carbonate Filler | 900 |
| Talc Filler | 250 |
| Clay Filler | 25 |
| Functional Filler | 50 |
| Colorant | 3 |

### Example 4: CLDP-3

The dampening layer formula for the example CLDP-3 and its ingredients can be found in Table 4 below:

TABLE 4

| Ingredient | Formula (wt. lbs) |
|---|---|
| Partially Crosslinked Butyl Rubber | 25 |
| IIR Butyl Rubber | 150 |
| Recycled Butyl Rubber | 38 |
| Plasticizer | 382 |
| Tackifier | 55 |
| Synthetic Rubber Plasticizer | 44 |
| Calcium Carbonate Filler | 900 |
| Talc Filler | 250 |
| Functional Filler | 50 |
| Colorant | 3 |

### Example 5: CLDP-4

The dampening layer formula for the example CLDP-4 and its ingredients can be found in Table 5 below:

TABLE 5

| Ingredient | Formula (wt. lbs) |
|---|---|
| Partially Crosslinked Butyl Rubber | 25 |
| IIR Butyl Rubber | 150 |
| Recycled Butyl Rubber | 25 |
| Plasticizer | 409.5 |
| Tackifier | 55 |
| Calcium Carbonate Filler | 900 |
| Talc Filler | 250 |
| Clay Filler | 25 |
| Functional Filler | 50 |
| Colorant | 3 |

### Example 6: CLDP-5

The dampening layer formula for the example CLDP-5 and its ingredients can be found in Table 6 below:

TABLE 6

| Ingredient | Formula (wt. lbs) |
|---|---|
| Partially Crosslinked Butyl Rubber | 25 |
| IIR Butyl Rubber | 150 |
| Recycled Butyl Rubber | 38 |
| Plasticizer | 426 |
| Tackifier | 55 |
| Calcium Carbonate Filler | 900 |
| Talc Filler | 250 |
| Clay Filler | 25 |
| Functional Filler | 50 |
| Colorant | 3 |

### Experiment 7: Peel Adhesion Strength Test

ISO 8510 Part 2 provides certain guidelines on peel adhesion tests. To prepare for such a test, a vibration dampening patch sample would be cut into a rectangular strip with a 1-inch width and a 13-inch length (this length is long enough to bend the strip up for 180-degree peeling). This vibration dampening patch invention is manufactured by a mass production scale process, so the performance of the sample strip is representative enough for such a design. The sample strip should avoid any noticeable defects.

The metal substrates used in this evaluation could include cold roll steel, hot dip galvanized steel, or electric galvanized steel, etc. They are cut into a rectangular shape with a 2-inch width and a 7-inch length. Prior to using it, the surface of the substrate should be thoroughly cleaned of any chemicals or contaminants. Isopropanol is effective in cleaning. After cleaning and drying, apply specified protective lubricants by a syringe on the substrate and spread it evenly across the whole area. In some embodiments, a lubricant that comprises 60-70% mineral oil may be used so as to provide a protective coating. Extra attention is really needed on spreading the lubricant, as a locally concentrated lubricant on the substrate surface will result in a weak spot for the sample strip to bond with the substrate. Furthermore, one should weigh the substrate before and after the lubricant is applied, so that the quantity of lubricant on the substrate can be determined and recorded. After the lubricant is applied, the now oily substrate should be allowed to dwell for at least 1 hour in a horizontal position before a sample strip is applied to it.

Half of the length of the sample strip is applied on the oily dwelled steel substrate. This is called “peel assembly”. The other half of the sample strip will be bent over for 180-degree peel. To ensure an ideal wet out between the sample strip's tacky surface to the substrate surface, a specified weight roller is used to roll on this assembly with a specified speed and specified cycles (an example is a 2.2 kg roller, with 10 mm/s speed, rolling twice in each direction). After the assembly is prepared, it should be allowed to dwell for a specified period, before commencing the peel test.

When ready to carry out the peeling test, install the peel assembly on a tensile tester. The free end of the sample strip is fixed to one of the grips on the tester, and the steel substrate is fixed to the other grip. The tester peels the sample strip from the steel substrate with a specified speed at a 180-degree angle. An example for peel speed is 100 mm/min.

Overall, the sample strip's adhesion on the oily substrate can be characterized by two aspects of the results from such peeling test. One is the average peel force in newtons, over a peel length of at least 100 mm, but not including the first 25 mm. The other is the separation modes between the sample strip and the oily substrate as a result of the peeling. The mode could be cohesive (i.e., the sample strip itself splits so that at least part of one surface of the strip remains adhered to the substrate) or adhesive (i.e., there is separation at the interface between the sample strip and the substrate). If the separation mode is a mix of cohesive and adhesive, the percentage of the area with cohesive or adhesive separation should be estimated.

From the above two aspects of the results, one can judge the sample strip's adhesion. Normally, it is desirable to have either higher peel force or more cohesive separation mode, or both. Cohesive separation is preferred because it indicates that the bonding force between the sample strip and the substrate exceeds the sample's own intrinsic force, so the likelihood that the sample would delaminate or separate from the substrate is low. A 100% cohesive separation that is achieved with high peel force is most preferred.

Some example results are shown in Table 7 below.

TABLE 7

| EXAMPLE | Force (N/cm) | Separation Mode |
|---|---|---|
| CE-1 | 8 | 10% Cohesive |
| CLDP-1 | 12 | 100% Cohesive |
| CLDP-2 | 13 | 50% Cohesive |
| CLDP-3 | 10 | 100% Cohesive |
| CLDP-4 | 9 | 100% Cohesive |
| CLDP-5 | 13 | 100% Cohesive |

1. An improved constrained layer vibration dampening patch comprising:
a constraining layer; and
a dampening layer; wherein the dampening layer is comprised of butyl rubber composite, a tackifier, a plasticizer, and a filler composite.

2. The improved constrained layer vibration dampening patch of claim 1, further comprising a release liner.

3. The improved constrained layer vibration dampening patch of claim 1, further comprising a colorant.

4. The improved constrained layer vibration dampening patch of claim 1, wherein the butyl rubber composite is comprised of a partially crosslinked butyl rubber and an isobutylene-isoprene butyl rubber composite.

5. The improved constrained layer vibration dampening patch of claim 4, wherein the isobutylene-isoprene butyl rubber composite is comprised of isobutylene-isoprene butyl rubber and recycled isobutylene-isoprene butyl rubber.

6. The improved constrained layer vibration dampening patch of claim 1, wherein the tackifier is selected from a rosin ester resin or an aliphatic hydrocarbon resin.

7. The improved constrained layer vibration dampening patch of claim 1, wherein the plasticizer comprises at least one isobutylene-butene copolymer, a pure isobutene homopolymer, or mixtures thereof.

8. The improved constrained layer vibration dampening patch of claim 1, wherein the filler composite is comprised of at least one functional filler and a general filler.

9. The improved constrained layer vibration dampening patch of claim 7, wherein the at least one functional filler is comprised of calcium oxide (CaO), talc, kaolin clay or mixtures thereof.

10. The improved constrained layer vibration dampening patch of claim 7, wherein the general filler is comprised of calcium carbonate (CaCO₃).

11. The improved constrained layer vibration dampening patch of claim 1, wherein the dampening layer is substantially free of an acceleration agent.

12. The improved constrained layer vibration dampening patch of claim 1, wherein the dampening layer is free of any ethylene copolymers.

13. A vibration dampening layer composition comprising:
about 10 to about 15 weight percent of a butyl rubber composition; about 1 to about 5 weight percent of a tackifier;
about 20 to about 25 weight percent of a plasticizer;
about 60 to about 65 weight percent of a filler; and
about 0.01 to 1 weight percent of a colorant,
wherein the composition is substantially free of a curing agent, and wherein the composition is free of any ethylene copolymers.

14. An improved constrained layer vibration dampening patch comprising:
a release liner;
a constraining layer;
a dampening layer comprising a first surface and a second surface; and an metal substrate to which the dampening system is adhered,
wherein the dampening layer comprises a first surface and a second surface,
wherein the constraining layer is in physical communication with the first surface of the dampening layer,
wherein the release liner is in physical communication with the second surface of the dampening layer,
wherein when the release liner is removed from the second surface of the dampening layer to expose the second surface of the dampening layer, the dampening layer is adhered to the metal substrate such that the second surface of the dampening layer is in physical communication with the metal substrate resulting in the dampening layer being intermediate the constraining layer and the metal substrate, and
wherein the dampening layer comprises about 10 to about 15 wt % of butyl rubber composite.

15. The improved vibration dampening patch of claim 14, wherein the butyl rubber composite comprises a poly-isobutylene butyl rubber and an isobutylene-isoprene butyl rubber composite.

16. The improved vibration dampening patch of claim 14, wherein the metal substrate comprises steel with a protective coating for the inhibition of rust.

17. The improved vibration dampening patch of claim 16, wherein the protective coating is comprised of about 60 weight percent to about 70 weight percent of mineral oil.

18. The improved vibration dampening patch of claim 14 wherein the dampening patch exhibits a peel adhesion strength of between 9 to 13 N/cm as measured according to ISO 8510.
